(19) United States
(12) Patent Application Publication
(10) Pub. No.: US 2023/0211688 A1
(43) Pub. Date: Jul. 6, 2023

(54) CHARGING POLE

(71) Applicant: ME ENERGY GMBH, Wildau (DE)

(72) Inventors: Alexander SOHL, Berlin (DE); Inès ADLER, Berlin (DE)

(73) Assignee: ME ENERGY GMBH, Wildau (DE)

(21) Appl. No.: 18/000,401

(22) PCT Filed: Jun. 1, 2021
(86) PCT No.: PCT/EP2021/064681

§ 371 Date: Dec. 1, 2022

(30) Foreign Application Priority Data
Jun. 2, 2020 (DE) 10 2020 114 676.0

(51) Int. Cl. B60L 53/57; H02J 7/14; H02J 7/34; B60L 53/53

(52) U.S. Cl. CPC B60L 53/57; H02J 7/143; H02J 7/342; H02J 7/1415; B60L 53/53; H02J 2207/20

(57) ABSTRACT

The invention relates to a method for generating and delivering charging current for an electric vehicle in a charging pole, comprising the steps of generating kinetic energy, feeding a first generator with the generated kinetic energy, feeding a second generator with the generated kinetic energy, converting the generated kinetic energy into electrical energy by means of the first generator, and converting the generated kinetic energy into electrical energy by means of the second generator.

The invention relates to a process for generating and delivering charging current for an electric vehicle in a charging pole, comprising the steps of generating kinetic energy, feeding a first generator with the generated kinetic energy and converting the generated kinetic energy into electrical energy by means of the first generator, as well as a corresponding device.

### STATE OF THE ART

The spread of electric vehicles powered by an electric motor is accompanied by a functioning infrastructure for charging the electric vehicles. In addition to charging at the household socket, users of electric vehicles must be given the opportunity to obtain energy in public areas. With the currently available ranges of electric vehicles, it is necessary that charging of the vehicles is also possible outside the domestic environment. Therefore, charging stations must be made available in public areas to ensure a constant availability of energy for electric vehicles through a supply network.

Charging poles are known for recharging the traction battery of a plug-in vehicle—hybrid or electric vehicle—as described, for example, in DE 10 2009 016 505 A1. The charging pole itself is connected to a bus bar of the power supply. An existing power grid has a connection element for outputting electrical energy to an electric vehicle.

It is therefore the task of the present invention to provide a process for charging electric vehicles, in which charging can be accomplished more cost-effectively. Furthermore, it is the task of the present invention to provide a charging pole for charging electric vehicles that can be operated more cost-effectively.

The task is solved by means of the process for generating and delivering charging current for an electric vehicle in a charging pole according to claim 1. Further advantageous embodiments of the invention are set out in the dependent claims.

The process for generating and delivering charging current for an electric vehicle in a charging pole according to the invention has three process steps: In the first process step, kinetic energy is generated. The kinetic energy occurs in particular as a translational and/or rotational movement and takes place in an energy conversion unit. The energy conversion unit is, for example, a combustion engine. The combustion engine is usually a piston combustion engine, but other combustion engines such as a Wankel engine or a turbine are also possible. By suitably selecting the starting time of a combustion engine, the charging process for a user is significantly reduced. In the second process step, a first generator is fed with kinetic energy from the energy conversion device. The first generator is coupled to and driven by the energy conversion unit. In the third process step, the kinetic energy generated by the energy conversion unit is converted into electrical energy by means of the first generator. The first generator driven by the energy conversion unit generates a current that is predominantly used to charge an electric vehicle.

According to the invention, a second generator is fed with kinetic energy from the energy conversion device. The second generator converts the kinetic energy into electrical energy. The second generator is also coupled to and driven by the energy conversion unit. The second generator produces a current that is primarily used to operate the charging pole.

Energy conversion units in the sense of the present invention are essentially carburetion engines that can be optionally operated with different fuels. They convert the energy of a liquid and/or gaseous energy carrier into kinetic energy. Energy conversion units are also understood to be fuel cells, wind turbines and/or solar cells. Furthermore, rectifiers and/or inverters are also understood as energy conversion units.

Due to this advantageous process, the charging pole can be operated completely self-sufficiently; it is not necessary to connect the charging pole to an external energy source, e.g. an existing power grid. This significantly reduces the costs for installing the charging pole compared to charging poles operated by medium-voltage grids, for example. At the same time, the location of the charging pole can be chosen more flexibly; a nearby power connection is not necessary. This feature is particularly important in rural areas.

In a further embodiment of the invention, the first generator and the second generator are supplied with kinetic energy from the same energy conversion device. The kinetic energy generated by the energy conversion unit is then converted into electrical energy by the first and second generators.

In another embodiment of the invention, the first generator produces an electric current having a voltage of more than 100V. The current generated by the first generator is typically a three-phase current with a voltage of 400V. This enables the charging pole to be designed for fast charging of electric vehicles.

In a further embodiment of the invention, the second generator produces an electric current with a voltage of less than 250V. Electrical voltages of 12V, 24V or 48V are usually required to operate the components installed in the charging pole. An electrical voltage of 220V generated by the second generator enables the operation of electrical devices such as are common in households. Due to the method according to the invention, the charging pole can therefore also be used as a domestic electricity generator in addition to charging electric vehicles.

In a further development of the invention, 100% of the electric current generated by the first generator is used for charging an electric vehicle. The current output of the first generator is scaled in such a way that charging of an electric vehicle is possible within a reasonable period of time. This power output is advantageously at least 3.7 kW, for fast charging at least 22 kW are required.

In another embodiment of the invention, the electricity generated by the second generator is used to charge an energy storage device located in the charging pole. The electric energy storage unit is usually a rechargeable battery, e.g. a Li-ion battery or an acid battery. Such an energy storage device has a high energy density, is technically mature and available.

In a further embodiment of the invention, the (rechargeable) energy storage device (battery) is arranged in the charging pole. The rechargeable battery, e.g. a Li-ion battery, requires so little space, depending on its energy content (capacity), that it can be arranged in a charging pole.

In a further embodiment of the invention, the first generator is supplied with the generated kinetic energy via a first linking element. The first linking element usually has a disengageable clutch and a toothed belt. A connection by V-belt or chain is also possible.

In a further development of the invention, the second generator is fed with the generated kinetic energy via a second linking element. The second linking element advantageously has a low-maintenance belt drive without an intermediate coupling.

In a further embodiment of the invention, the second coupling device is arranged separately from the first coupling arrangement. Therefore, each linking element is separately accessible and easy to maintain and repair in case of maintenance.

In another embodiment of the invention, the electricity generated by the second generator is used to operate an HMI unit, a controller and/or a communication unit. The HMI unit, the controller and/or the communication unit are arranged in the charging pole. By means of the HMI unit, data important to a user, such as charging current, charging time and cost of the charging process, are retrieved and displayed. In addition, a user can initiate or terminate the charging process as well as pay. The power unit primarily enables the conversion of electrical energy in terms of voltage form (e.g. direct or alternating voltage), the level of voltage and current as well as the frequency.

In a further embodiment of the invention, the electrical power generated by the second generator is used for charging an electric vehicle. In addition to supplying electrical power to the charging pole components, the electrical power generated by the second generator can also be used to charge an electric vehicle. The charging process can thus be accelerated by feeding more electrical power into the electric vehicle. Alternatively or additionally, the charging pole's energy storage unit (electric energy storage unit), which is charged by the second generator, can be used for the charging process.

The task is further solved by the charging pole according to the invention, which is suitable for charging electric vehicles and is provided therefor, according to claim 12.

The charging pole according to the invention, which is suitable for charging electric vehicles, has an energy conversion unit and a first generator connected to the energy conversion unit. The energy conversion unit is, for example, a combustion engine. The combustion engine is usually a piston combustion engine, but other combustion engines such as a Wankel engine or a turbine are also possible. The first generator is coupled to and driven by the energy conversion unit. The first generator driven by the energy conversion unit generates a current which is predominantly used for charging an electric vehicle.

According to the invention, a second generator is connected to the energy conversion unit. The second generator is also coupled to and driven by the energy conversion unit. The second generator produces a current which is primarily used to operate the charging pole. Due to this advantageous arrangement of the generators, the charging pole according to the invention can be operated completely self-sufficiently; it is not necessary to connect the charging pole to an external energy source, e.g. an existing power grid. This significantly reduces the costs for installing the charging pole compared to charging poles operated by medium-voltage grids, for example. At the same time, the location of the charging pole can be chosen more flexibly; a power connection in the immediate vicinity is not necessary. This feature is particularly important for the use of the charging pole according to the invention in rural areas.

In another embodiment of the invention, the first generator and the second generator are each connected to the energy conversion unit via separate linking elements. The first linking element usually has a disengageable clutch and a toothed belt. A V-belt or chain connection is also possible. The second linking element advantageously has a low-maintenance belt drive without an intermediate coupling. Due to the separate arrangement, the linking elements are separately accessible and can be maintained or repaired separately in case of maintenance.

In another embodiment of the invention, the first generator is connected to the connection for a charging cable via a power line suitable and intended for conducting the generated current. The electrical energy generated by the first generator is used to charge the energy storage device of an electric vehicle. The charging cable is used to connect the charging pole to the energy storage device of the electric vehicle.

In a further embodiment of the invention, the first generator is connected to one or more charging cable connections exclusively via one or more power lines which are suitable and intended for conducting the generated current. By means of a charging cable, the connection between the charging pole and the energy storage device of an electric vehicle to be charged is made. Multiple charging cable connections allow simultaneous charging of multiple electric vehicles. The electrical power generated by the first generator is then shared between several electric vehicles.

In another embodiment of the invention, a first rectifier is connected between the first generator and the charging cable connection. The first generator usually produces an alternating current. However, a battery storage device of an electric vehicle requires a direct current for charging. By means of a rectifier arranged in the charging pole according to the invention, no rectifier is necessary in the electric vehicle to be charged, whereby costs and weight of the electric vehicle can be reduced.

In another embodiment of the invention, the second generator is connected to a battery via a power line suitable and intended to conduct the generated current. The charging pole is therefore operated autonomously by the electrical energy stored in the battery. It is not necessary to connect the charging pole to an external energy source, e.g. a power line, and the costs of installing the charging pole are thus reduced.

In a further embodiment of the invention, a second rectifier is connected between the second generator and the battery. The electrical energy stored in the battery is fed as direct current to the energy storage unit of the electric vehicle to be charged. The rectifier functions in particular as a power unit that adjusts the charging state of the electric vehicle to be charged, the charging voltage and the charging current of the charging pole. The charging pole according to the invention thus charges an electric vehicle to be charged not only with the electrical energy generated by the generator unit, but also additionally with the electrical energy stored in the battery. This significantly shortens the charging time. Alternatively, a second electric vehicle can be charged in parallel.

In a further embodiment of the invention, the battery is connected to the energy conversion unit via a power line, the power line being provided for and adapted to supply electrical energy to the engine. The motor requires electrical energy for starting and operation. The charging pole is therefore operated autonomously by the electrical energy stored in the battery. It is not necessary to connect the charging pole to an external energy source, e.g. a power line, and the costs for installing the charging pole are thus reduced.

In a further embodiment of the invention, the second generator is connected to an HMI unit, a communication unit and/or a controller via a power line suitable and intended to conduct the generated current. The stand-by mode of the charging pole requires a small supply of energy from the HMI unit and the power unit in order to function. This energy supply is provided by the battery. Start-up and operation of the HMI unit and the power unit also take place with stored electrical energy in the battery. The charging pole is therefore operated autonomously by the electrical energy stored in the battery. Connecting the charging pole to an external energy source, e.g. a power line, is not necessary, thus reducing the costs for installing the charging pole.

In a further embodiment of the invention, the battery is connected to the first rectifier via an inverter and a power line. The electrical energy stored in the battery is fed as direct current to the inverter, which converts the direct current into an alternating current. The rectifier connected afterwards converts the alternating current back into direct current. The inverter and rectifier both function as a power unit that adjusts the charging state of the electric vehicle to be charged, the charging voltage and the charging current of the charging pole.

In a further embodiment of the invention, the battery is connected to the charging cable connection via a DC converter and a power line. The electrical energy stored in the battery is fed as direct current to the energy storage unit of the electric vehicle to be charged. In particular, the rectifier functions as a power unit that adjusts the charging state of the electric vehicle to be charged, the charging voltage and the charging current of the charging pole.

The rectifier can also be a power supply unit or have the functional scope of a power supply unit. The charging pole according to the invention thus charges an electric vehicle to be charged not only with the electrical energy generated by the generator unit, but also additionally with the electrical energy stored in the battery. This significantly shortens the charging time. Alternatively or additionally, a second electric vehicle can be charged in parallel.

In a further embodiment of the invention, the first generator is designed and adapted to generate current at a voltage greater than 100V. The current generated by the first generator is usually a three-phase current with a voltage of 400V. This enables the charging pole to be designed for fast charging of electric vehicles.

In another embodiment of the invention, the second generator is provided for and suitable for generating current with a voltage lower than 250V. Electrical voltages of 12V, 24V or 48V are usually required to operate the components installed in the charging pole. An electrical voltage of 220V generated by the second generator enables the operation of electrical devices such as are common in households. In addition to charging electric vehicles, the charging pole can therefore also be used as a household generator.

Examples of embodiments of the method for charging electric vehicles according to the invention and of the charging pole according to the invention are shown schematically in simplified form in the drawings and are explained in more detail in the following description.

### SHOWING

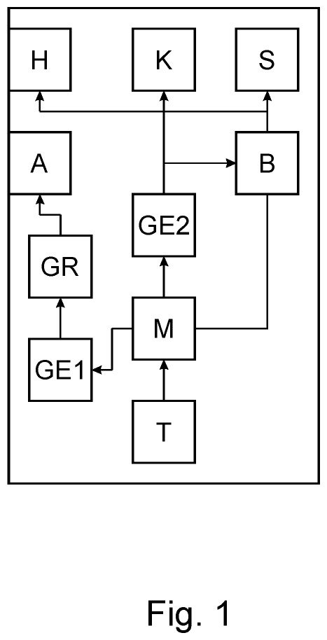

FIG. 1: An example of the charging pole according to the invention.

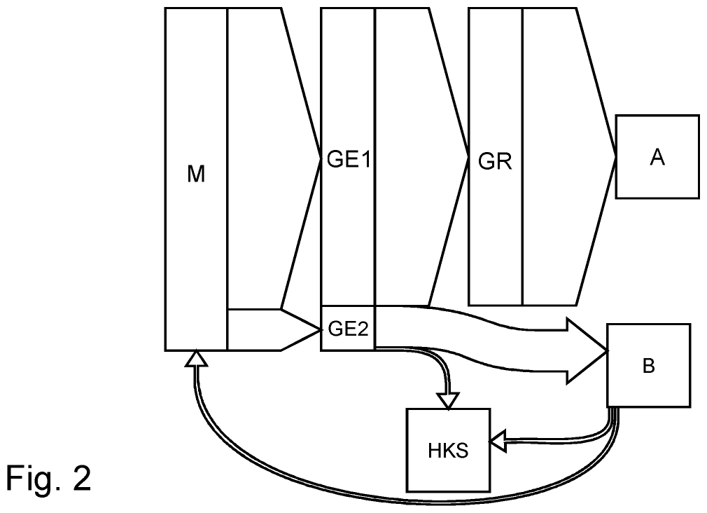

FIG. 2: A diagram of an example of energy distribution during the charging process.

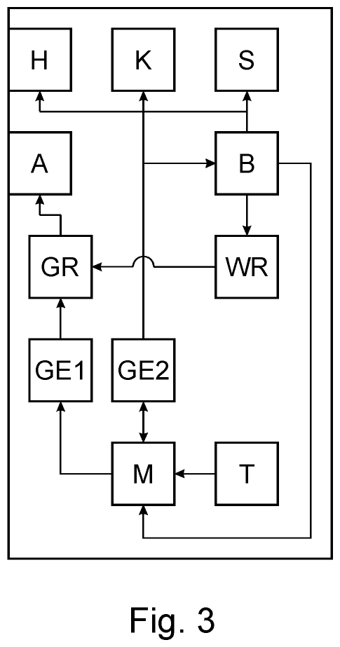

FIG. 3: A further example of the charging pole according to the invention.

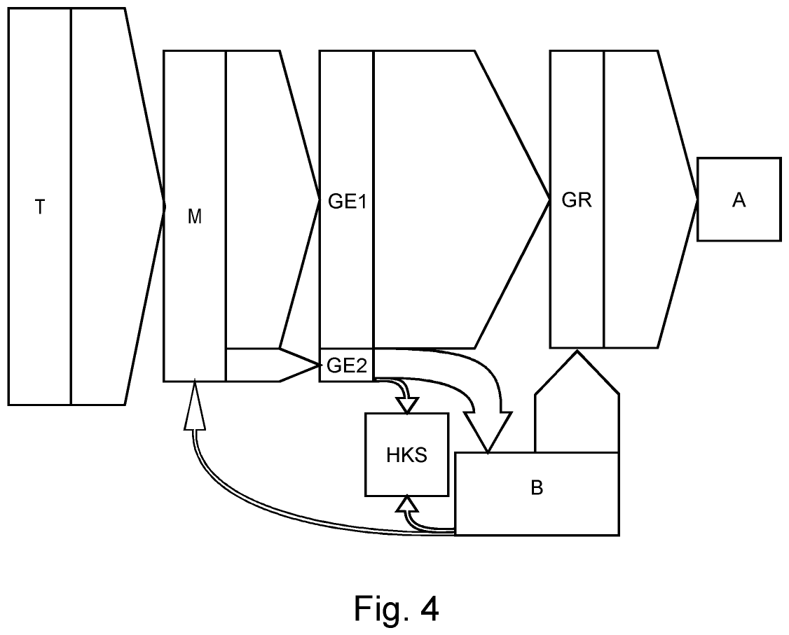

FIG. 4: A diagram of another embodiment of the energy distribution during the charging process.

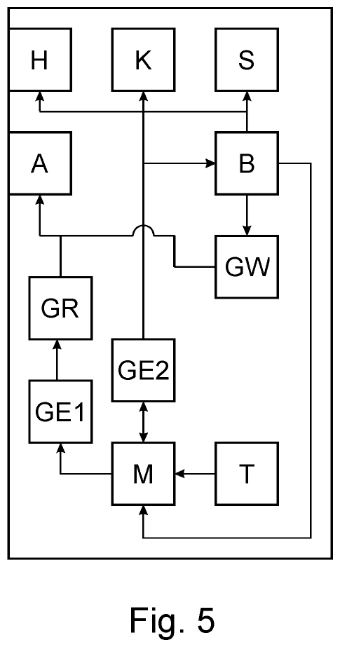

FIG. 5: Another example of the charging pole according to the invention.

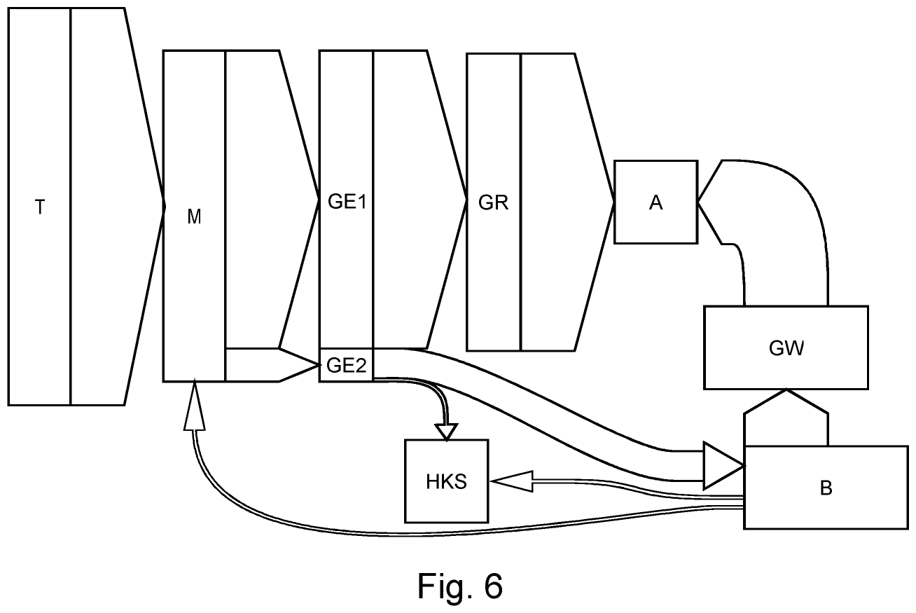

FIG. 6: A diagram of another embodiment of the energy distribution during the charging process.

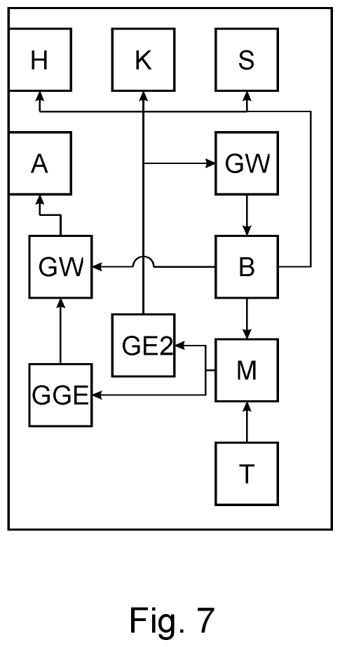

FIG. 7: Another example of the charging pole according to the invention.

FIG. 1 shows a schematic view of the charging pole 1 according to the invention with representation of the connections by means of power lines between the components within the charging pole 1. In this embodiment example, the charging pole 1 according to the invention has a nominal power of 150 kW, i.e. an electric vehicle can be charged with 150 kW charging power. In the charging pole 1, in this embodiment example, the electrical energy for delivery to an electric vehicle is generated by a combustion engine M as an energy conversion unit. The combustion engine M is here a piston combustion engine with a shaft power of 180 kW, but other designs such as a Wankel engine or turbine are also possible. The combustion engine M is advantageously operated with methanol or ethanol or a mixture of methanol and ethanol. The fuels can be produced in a climate-neutral way, e.g. from vegetable raw materials, and their storage and handling is comparable to the storage of conventional petrol and therefore does not require any extraordinary safety measures for safe storage and transport.

Such a fuel typically has a usable energy content of 6.28 kWh/I and is the primary energy source of the charging pole 1. The fuel is stored in the charging pole 1 in a tank T. The combustion engine M is connected to the first generator GE1 via the first linking element KE1. The linking element KE1 usually has a disengageable clutch and a toothed belt. A connection by V-belt or chain is also possible. The first generator GE1 is advantageously a three-pole three-phase synchronous generator self-excited by permanent magnets. Such a generator does not require any energy to generate the magnetic field and therefore has a higher efficiency of approx. 98% compared to externally excited generators. In addition, a synchronous generator can produce a specifically adjustable power to compensate for the reactive power that inevitably occurs in the charging pole 1.

The combustion engine M drives the first generator GE1 by rotation. The kinetic energy generated by the combustion engine M is thus converted by the first generator GE1 into electrical energy, into an alternating current. The first generator GE1 generates an electrical power of 150 kW at a voltage of more than 100V according to the invention, 400V in this and the following embodiment examples. The alternating current generated by the generator GE1 is converted into a direct current in the rectifier GR1. The combustion engine M is connected to a second generator GE2 via the second linking element KE2, which is arranged separately from the first linking element KE1. The second linking element KE2 has a low-maintenance belt drive without a clutch. The second generator GE2 is also driven like the first generator GE1 by rotation of the combustion engine M, the kinetic energy of the combustion engine M is converted into electrical energy. Like the first generator GE1, the second generator GE2 is a self-excited synchronous generator with high efficiency. The second generator GE2 generates a direct current with a voltage of up to 250V according to the invention, in this embodiment example of 24V.

The HMI unit H has a display and operating terminal on which the data important to a user, such as charging current, charging duration and costs of the charging process, are called up and displayed. In addition, a user can initiate or end the charging process and pay. Various payment systems are possible, e.g. via different credit cards. Other payment systems are also possible, e.g. via a mobile end device (smartphone). The rechargeable battery B (battery) has a capacity of 50 kWh and is charged by the second generator GE2 during the charging of the electric vehicle. At the same time, the battery B supplies the control unit S, the communication unit K and the HMI unit H with electrical energy for operation as well as the combustion engine M with electrical energy for starting and operation.

The charging pole 1 also has the connection device A for one or more charging cables with which an electric vehicle to be charged is charged. The charging cable also has a data line that establishes a data connection between the control unit S and the electric vehicle. Communication with the battery of the electric vehicle to be charged is established via the data line and the required data such as state of charge, charging voltage and charging current are queried. The control unit S sets the parameters of the charging current on the basis of this data. The charging pole 1 is connected to the operator of the charging pole 1 and a plurality of other charging poles via the communication unit K, which establishes an internet connection, e.g. with a cloud storage.

All these charging pole 1 components mentioned here—tank T, combustion engine M, the linking elements KE1, KE2, first generator GE1, second generator GE2, rectifier GR, connection device A, battery B, HMI unit H, communication unit K, control unit S—are advantageously arranged in the charging pole 1 itself. For this purpose, the charging pole 1 has a housing that protects the components inside the charging pole 1 from the effects of the weather and damage.

The process for generating and charging an electric vehicle begins with the generation of kinetic energy by the energy conversion unit, in this embodiment the combustion engine M. Up to this point, the charging pole 1 is in stand-by mode, in which only the control unit S, the communication unit K and the HMI unit H are operational. These units H, K, S are supplied with electrical energy by the battery B. The control unit S, the communication unit K and the HMI unit H require 70 W for stand-by operation.

The process according to the invention is initiated by a starting process, in this embodiment example by connecting the charging cable to the electric vehicle to be charged. By means of a plug-in connection, charging pole 1 and electric vehicle are connected through the charging cable connected to connection device A. The starting process puts the charging pole 1 into an operating state. For this purpose, the energy conversion process is started first. A starting device installed on the combustion engine M starts the combustion engine M, which is supplied with fuel from the tank T. The starting device is connected to the charging cable. An electrical power of 500 W is required for the start and operation of the combustion engine M, which is provided by the battery B.

The procedure according to the invention can also be initiated by sensors, e.g. a radar sensor, which detects the electric vehicle to be charged at the parking space assigned to the charging pole 1. It is also possible for a user to pre-announce by means of a mobile end device, e.g. a smartphone with a suitable app, that the procedure according to the invention will start in a specified time window. A combination of the aforementioned possibilities is also conceivable. The first generator GE1 coupled to the combustion engine M is driven by the kinetic energy of the combustion engine M and generates electrical energy. This electrical energy generated by the first generator GE1 is used exclusively and 100% for charging the electric vehicle. In alternative applications, part of the energy generated by the first generator GE1 can also be used to charge the energy storage device. The second generator GE2, which is also coupled to the combustion engine M, is also driven by the kinetic energy of the combustion engine M and generates electrical energy. This electrical energy generated by the second generator GE2 is used to charge the energy storage device located in the charging pole 1 and to operate the HMI unit H, the control unit S and the communication unit K during the charging of the electric vehicle. Thereafter, the process of charging the electric vehicle is performed by the electric energy generated by the generator GE1. Typically, a user gives a start command for charging via the HMI unit H. The electric vehicle is supplied with electrical energy by the charging pole 1 through the charging cable connected to the connection device A, in this embodiment example with a maximum of 150 kW. After the electric vehicle has been charged, the energy conversion process is terminated, the combustion engine M is stopped and the process of charging the electric vehicle is terminated. No more electrical energy flows from the charging pole 1 to the electric vehicle. The charging pole 1 is returned to stand-by mode.

An embodiment example of the energy flow during the charging process between the components of the charging pole 1 is shown in FIG. 2. The combustion engine M as an energy conversion unit generates a nominal power of 180 kW, which is transmitted to the generators GE1 and GE2. The first generator GE1 generates an electric current with the power of 150 kW, the second generator GE2 generates a current power of 6 kW. The 30 kW of electric power generated by the second generator GE2 is sent to battery B to charge it. With 70 W of the power generated by the first generator GE1, power is supplied to control unit S, communication unit K and HMI unit H. Therefore, 150 kW enters the rectifier GR. The alternating current generated by the first generator GE1 is converted into a direct current in the rectifier GR. The direct current (150 kW) generated by rectifier GR is fed into the charging cable located at connection device A. The battery B with a capacity of 50 kWh supplies the control unit S, the communication unit K and the HMI unit H with a total of 70 W and the combustion engine M with 500 W in stand-by mode.

As explained, the charging pole 1 according to the invention is thus supplied with energy by the electrical energy stored in the battery B, the generator GE2 feeding it and ultimately by the fuel stored in the tank T as the primary energy source. The charging pole 1 according to the invention therefore does not require an external energy source, e.g. a power connection, for charging an electric vehicle. Experience has shown that the cost of connecting to an external power source requires a great deal of effort and is associated with high costs. The charging pole 1 according to the invention is cheaper to install than, for example, a charging pole that draws its primary current from the available power grid.

The process according to the invention is initiated by a start-up process. Up to this point, the charging pole 1 is in a stand-by mode in which only the control unit S, the communication unit K and the HMI unit H are ready for operation. The start-up process puts the charging pole 1 into an operating state. For this purpose, the energy conversion process is first started with the aid of the energy conversion unit, in this embodiment an internal combustion engine. A starting device installed on the combustion engine M starts the combustion engine M, which is supplied with fuel from the tank T. The combustion engine M is started by the starting device. The first generator GE1 coupled to the combustion engine M is driven by the kinetic energy of the combustion engine M and generates electrical energy. This electrical energy generated by the first generator GE1 is used exclusively and 100% for charging the electric vehicle.

The second generator GE2, also coupled to the combustion engine M, is also driven by the kinetic energy of the combustion engine M and generates electrical energy. This electrical energy generated by the second generator GE2 is used to charge the energy storage device located in the charging pole 1 and to operate the HMI unit H, the control unit S and the communication unit K during the charging of the electric vehicle. Thereafter, the process of charging the electric vehicle is performed by the electric energy generated by the generator GE1. Typically, a user gives a start command for charging via the HMI unit H. The electric vehicle is supplied with electrical energy by the charging pole 1 through the charging cable connected to the connection device A, in this embodiment example with a maximum of 150 kW. After the electric vehicle has been charged, the energy conversion process is terminated, the combustion engine M is stopped and the process of charging the electric vehicle is terminated. No more electrical energy flows from the charging pole 1 to the electric vehicle. The charging pole 1 is returned to stand-by mode.

FIG. 3 shows a schematic view of the charging pole 1 according to the invention with representation of the connections by means of power lines between the components within the charging pole 1. In this embodiment example, the charging pole 1 has an inverter WR. In the charging pole 1, the electrical energy for delivery to an electric vehicle is generated by the combustion engine M as an energy conversion unit. The combustion engine M is a piston combustion engine with a shaft power of 70 kW, the combustion engine M is operated with methanol or ethanol or a mixture of methanol and ethanol. The fuel is stored in the charging pole 1 in the tank T.

The combustion engine M drives the first generator GE1 by rotation. The kinetic energy generated by the combustion engine M is thus converted by the first generator GE1 into electrical energy, into an alternating current. The combustion engine M is connected to the first generator GE1 via the first linking element KE1. The first generator GE1 generates an electrical power of 50 kW. The alternating current generated by the first generator GE1 is converted into a direct current in the rectifier GR. The combustion engine M is connected to a second generator GE2 via the second linking element KE2, which is arranged separately from the first linking element KE1. The second generator GE2 is also driven like the first generator GE1 by rotation of the combustion engine M, the kinetic energy of the combustion engine M is converted into electrical energy. The second generator GE2 generates a direct current with a voltage of 12V.

The HMI unit H has the display and operating terminal on which the data important for a user, such as charging current, charging duration and costs of the charging process, are called up and displayed. In addition, a user can initiate or end the charging process and pay. The rechargeable battery B (battery) has a capacity of 50 kWh and is charged by the second generator GE2 during the charging of the electric vehicle. At the same time, the battery B supplies the control unit S, the communication unit K and the HMI unit H with electrical energy for operation, as well as the combustion engine M with electrical energy for starting and operation. The charging pole 1 also has the connection device A for one or more charging cables used to charge an electric vehicle to be charged. The charging cable also has a data line that establishes a data connection between the control unit S and the electric vehicle. Communication with the battery of the electric vehicle to be charged is established via the data line and the required data such as state of charge, charging voltage and charging current are queried. The control unit S sets the parameters of the charging current on the basis of this data. The charging pole 1 is connected to the operator of the charging pole 1 and a plurality of charging poles via the communication unit K, which establishes an internet connection, e.g. with a cloud storage. In this embodiment example, the battery B is connected to the connection device A for the charging cable via an inverter WR and the rectifier GR. During the charging process, the inverter GW and rectifier GR function as a power unit that adjusts the charging state of the electric vehicle to be charged, the charging voltage and the charging current of the charging pole 1.

The process according to the invention is initiated by a start-up process. Up to this point, the charging pole 1 is in a stand-by mode in which only the control unit S, the communication unit K and the HMI unit H are ready for operation. The start-up process puts the charging pole 1 into an operating state. For this purpose, the energy conversion process is started first. A starting device installed on the combustion engine M (energy conversion unit) starts the combustion engine M, which is supplied with fuel from the tank T. The combustion engine M is started by the energy conversion unit. The first generator GE1 coupled to the combustion engine M is driven by the kinetic energy of the combustion engine M and generates electrical energy. This electrical energy generated by the first generator GE1 is used exclusively and 100% for charging the electric vehicle. The second generator GE2, which is also coupled to the combustion engine M, is also driven by the kinetic energy of the combustion engine M and generates electrical energy. This electrical energy generated by the second generator GE2 is used to charge the energy storage device located in the charging pole 1 and to operate the HMI unit H, the control unit S and the communication unit K during the charging of the electric vehicle. Thereafter, the process of charging the electric vehicle is performed by the electric energy generated by the generator GE1. Typically, a user gives a start command for charging via the HMI unit H. The electric vehicle is supplied with electrical energy by the charging pole 1 through the charging cable connected to the connection device A, in this embodiment example with a maximum of 150 kW.

After the electric vehicle has been charged, the energy conversion process is terminated, the combustion engine M is stopped and the process of charging the electric vehicle is terminated. No more electrical energy flows from the charging pole 1 to the electric vehicle. The charging pole 1 is returned to stand-by mode.

Another embodiment example of the energy flow during the charging process between the components of the charging pole 1 is shown in FIG. 4. The primary energy source for the charging process is the fuel (methanol/ethanol or a mixture of methanol and ethanol) stored in the tank T with an assumed usable energy content of 6.28 kWh/I. The combustion engine M (energy conversion unit) generates a nominal power of 70 kW, which is transmitted to the generators GE1 and GE2. The first generator GE1 produces an electric current with the power of 50 kW, the second generator GE2 produces an electric current power of 5 kW. The 5 kW of electric power generated by the second generator GE2, minus 70 W, is sent to battery B to charge it. With 70 W of the power generated by the second generator GE2, the control unit S, the communication unit K and the HMI unit H are supplied with power. Therefore, 50 kW of power generated by the first generator GE1 enters the rectifier GR. The alternating current generated by the first generator GE1 is converted into a direct current in the rectifier GR. The direct current (50 kW) generated by rectifier GR is fed into the charging cable located at connection device A. The battery B with a capacity of 50 kWh supplies the control unit S, the communication unit K and the HMI unit H with a total of 70 W and the combustion engine M with 500 W in stand-by mode. In addition, in this embodiment example, the battery B feeds the rectifier GR with 50 kW of current power. This 50 kW of power is also fed as direct current, in addition to the approximately 50 kW of power generated by the first generator GE1, to the energy storage unit of the electric vehicle to be charged and/or to a second electric vehicle to be charged, which is connected to the charging pole 1 by means of a second charging cable connected to the connection device A. The rectifier GR functions in particular as a power unit. Due to this advantageous configuration of the method according to the invention, the charging time is significantly reduced.

The process according to the invention is initiated by a start-up process. Up to this point, the charging pole 1 is in a stand-by mode in which only the control unit S, the communication unit K and the HMI unit H are ready for operation. The start-up process puts the charging pole 1 into an operating state. For this purpose, the energy conversion process is started first. A starting device installed on the combustion engine M as the energy conversion unit of this embodiment starts the combustion engine M, which is supplied with fuel from the tank T. The combustion engine M is started by the communication unit K. The first generator GE1 coupled to the combustion engine M is driven by the kinetic energy of the combustion engine M and generates electrical energy. This electrical energy generated by the first generator GE1 is used exclusively and 100% for charging the electric vehicle. The second generator GE2, which is also coupled to the combustion engine M, is also driven by the kinetic energy of the combustion engine M and generates electrical energy. This electrical energy generated by the second generator GE2 is used to charge the energy storage device located in the charging pole 1 and to operate the HMI unit H, the control unit S and the communication unit K during the charging of the electric vehicle. Thereafter, the process of charging the electric vehicle is performed by the electric energy generated by the generator GE1. Typically, a user gives a start command for charging via the HMI unit H. The electric vehicle is supplied with electrical energy by the charging pole 1 through the charging cable connected to the connection device A, in this embodiment example with a maximum of 150 kW. After the electric vehicle has been charged, the energy conversion process is terminated, the combustion engine M is stopped and the process of charging the electric vehicle is terminated. No more electrical energy flows from the charging pole 1 to the electric vehicle. The charging pole 1 is returned to stand-by mode.

FIG. 5 shows a schematic view of the charging pole 1 according to the invention, showing the connections by means of power lines between the components within the charging pole 1. In this embodiment, the charging pole 1 also has an inverter WR. In the charging pole 1, the electrical power for delivery to an electric vehicle is generated by the energy conversion unit, the combustion engine M. The combustion engine M is a piston combustion engine with a shaft power of 220 kW, the combustion engine M is operated with methanol or ethanol or a mixture of methanol and ethanol. The fuel is stored in the charging pole 1 in the tank T.

The combustion engine M drives the first generator GE1 by rotation. The kinetic energy generated by the combustion engine M is thus converted by the first generator GE1 into electrical energy, into an alternating current. The combustion engine M is connected to the first generator GE1 via the first linking element KE1. The first generator GE1 generates an electrical power of 200 kW. The alternating current generated by the first generator GE1 is converted into a direct current in the rectifier GR. The combustion engine M is connected to a second generator GE2 via the second linking element KE2, which is arranged separately from the first linking element KE1. The second generator GE2 is also driven like the first generator GE1 by rotation of the combustion engine M, the kinetic energy of the combustion engine M is converted into electrical energy. The second generator GE2 generates a direct current with a voltage of 48V.

The HMI unit H has the display and operating terminal on which the data important for a user, such as charging current, charging duration and costs of the charging process, are called up and displayed. In addition, a user can initiate or end the charging process and pay. The rechargeable battery B (battery) has a capacity of 50 kWh and is charged by the second generator GE2 during the charging of the electric vehicle. At the same time, the battery B supplies the control unit S, the communication unit K and the HMI unit H with electrical energy for operation, as well as the combustion engine M with electrical energy for starting and operation.

The charging pole 1 also has the connection device A for one or more charging cables with which an electric vehicle to be charged is charged. The charging cable also has a data line that establishes a data connection between the control unit S and the electric vehicle. Communication with the battery of the electric vehicle to be charged is established via the data line and the required data such as state of charge, charging voltage and charging current are queried. The control unit S sets the parameters of the charging current on the basis of this data. The charging pole 1 is connected to the operator of the charging pole 1 and a plurality of charging poles via the communication unit K, which establishes an internet connection, e.g. with a cloud storage.

In this example, the battery B is connected to the connection device A for the charging cable via an inverter WR and the rectifier GR. During the charging process, the inverter GW and rectifier GR function as a power unit that adjusts the charging state of the electric vehicle to be charged, the charging voltage and the charging current of the charging pole 1. In this example, a first electric vehicle to be charged is charged with approximately 200 kW DC generated by the first generator GE1. A second electric vehicle to be charged is charged with 50 kW alternating current by the battery B.

The process according to the invention is initiated by a start-up process. Up to this point, the charging pole 1 is in a stand-by mode in which only the control unit S, the communication unit K and the HMI unit H are ready for operation. The start-up process puts the charging pole 1 into an operating state. For this purpose, the energy conversion process is first started in the energy conversion unit (combustion engine M). A starting device installed on the combustion engine M starts the combustion engine M, which is supplied with fuel from the tank T.

The first generator GE1 coupled to the combustion engine M is driven by the kinetic energy of the combustion engine M and generates electrical energy. This electrical energy generated by the first generator GE1 is used exclusively and 100% for charging the electric vehicle. The second generator GE2, which is also coupled to the combustion engine M, is also driven by the kinetic energy of the combustion engine M and generates electrical energy. This electrical energy generated by the second generator GE2 is used to charge the energy storage device located in the charging pole 1 and to operate the HMI unit H, the control unit S and the communication unit K during the charging of the electric vehicle.

Then the process of charging the electric vehicle by the electrical energy generated by the generator GE1 takes place. Typically, a user gives a start command for charging through the HMI unit H. The electric vehicle is supplied with electrical energy by the charging pole 1 through the charging cable connected to the connection device A, in this embodiment example with a maximum of 200 kW. Once the electric vehicle has been charged, the energy conversion process is terminated, the combustion engine M is stopped and the process of charging the electric vehicle is terminated. No more electrical energy flows from the charging pole 1 to the electric vehicle. The charging pole 1 is returned to stand-by mode.

Another embodiment example of the energy flow during the charging process between the components of the charging pole 1 is shown in FIG. 6. The primary energy source for the charging process is the fuel (methanol/ethanol or a mixture of methanol and ethanol) stored in the tank T with an assumed usable energy content of 6.28 kWh/I. The combustion engine M (energy conversion device) generates a nominal power of 220 kW, which is transmitted to the generators GE1 and GE2. The first generator GE1 produces an electric current with the power of 200 kW, the second generator GE2 produces an electric current with the power of 5 kW. The 5 kW of electric power generated by the second generator GE2, minus 70 W, is sent to battery B to charge it. With 70 W of the power generated by the second generator GE2, power is supplied to control unit S, communication unit K and HMI unit H.

Therefore, 200 kW of power, generated by the first generator GE1, enters rectifier GR. The alternating current generated by the first generator GE1 is converted into a direct current in the rectifier GR. The direct current (200 kW) generated by rectifier GR is fed into the charging cable located at connection device A. The battery B with a capacity of 50 kWh supplies the control unit S, the communication unit K and the HMI unit H with a total of 70 W and the combustion engine M with 500 W in stand-by mode. In addition, in this embodiment example, the battery B feeds the rectifier GR with 50 kW of current power. These 50 kW of power are also fed as direct current, in addition to the 200 kW of power generated by the first generator GE1, to the energy storage device of the electric vehicle to be charged and/or to a second electric vehicle to be charged, which is connected to the charging pole 1 by means of a second charging cable connected to the connection device A. The rectifier GR functions in particular as a power unit. Due to this advantageous configuration of the method according to the invention, the charging time is significantly reduced.

The process according to the invention is initiated by a start-up process. Up to this point, the charging pole 1 is in a stand-by mode in which only the control unit S, the communication unit K and the HMI unit H are ready for operation. The start-up process puts the charging pole 1 into an operating state. For this purpose, the energy conversion process is started first. A starting device installed on the combustion engine M (energy conversion unit) starts the combustion engine M, which is supplied with fuel from the tank T. The first generator GE1 coupled to the combustion engine M is driven by the kinetic energy of the combustion engine M and generates electrical energy. This electrical energy generated by the first generator GE1 is used exclusively and 100% for charging the electric vehicle.

The second generator GE2, also coupled to the combustion engine M, is also driven by the kinetic energy of the combustion engine M and generates electrical energy. This electrical energy generated by the second generator GE2 is used to charge the energy storage unit located in the charging pole 1 and to operate the HMI unit H, the control unit S and the communication unit K during charging of the electric vehicle.

Then the process of charging the electric vehicle by the electrical energy generated by the generator GE1 takes place. Typically, a user gives a start command for charging through the HMI unit H. The electric vehicle is supplied with electrical energy by the charging pole 1 through the charging cable connected to the connection device A, in this embodiment example with a maximum of 250 kW (200 kW by the first generator GE1, 50 kW by the battery B). After the electric vehicle has been charged, the energy conversion process is terminated, the combustion engine M is stopped and the process of charging the electric vehicle is terminated. No more electrical energy flows from the charging pole 1 to the electric vehicle. The charging pole 1 is returned to stand-by mode.

### REFERENCE LIST

1 Charging pole
H HMI unit
GW DC converter
GE1 1. generator
GE2 2. generator
S Control unit
K Communication unit
B Battery/electric energy storage unit
A Connection device for charging cable
T Tank unit
GR1, GR2 Rectifier
WR Inverter
KE1 1. linking element
KE2 2. linking element
G Housing
M Energy conversion unit (combustion engine)

Patent claims:

1. A process for generating and delivering charging current for an electric vehicle in a charging pole, comprising the following process steps
generating kinetic energy with an energy conversion unit
feeding a first generator with the generated kinetic energy
converting the generated kinetic energy into electrical energy by means of the first generator
characterised in that
a second generator is fed with the generated kinetic energy, and
the generated kinetic energy is converted into electrical energy by means of the second generator.

2. The process for generating and delivering charging current for an electric vehicle in a charging pole according to claim 1
characterised in that
the first generator produces an electric current with a voltage greater than 100V.

3. The process for generating and delivering charging current for an electric vehicle in a charging pole according to claim 2
characterised in that
the second generator produces an electric current with a voltage lower than 250V.

4. The process for generating and delivering charging current for an electric vehicle in a charging pole according to claim 1,
characterised in that
80%, preferably 90% and particularly preferably 100% of the electricity generated by the first generator is used for charging an electric vehicle.

5. The process for generating and delivering charging current for an electric vehicle in a charging pole according to claim 1,
characterised in that
the electricity generated by the second generator is used to charge an energy storage device associated in the charging pole.

6. The process for generating and delivering charging current for an electric vehicle in a charging pole according to claim 5
characterised in that
the battery is located in the charging pole.

7. The process for generating and delivering charging current for an electric vehicle in a charging pole according to claim 1,
characterised in that
the first generator is fed with the generated kinetic energy via a first coupling device.

8. The process for generating and delivering charging current for an electric vehicle in a charging pole according to claim 1,
characterised in that
the second generator is fed with the generated kinetic energy via a second coupling device.

9. The process for generating and delivering charging current for an electric vehicle in a charging pole according to claim 8
characterised in that
the second coupling device is arranged separately from the first coupling device.

10. The process for generating and delivering charging current for an electric vehicle in a charging pole according to claim 8
characterised in that
the first generator is coupled to the energy conversion device via the first coupling device and the second generator is coupled to the energy conversion device via the second coupling device.

11. The process for generating and delivering charging current for an electric vehicle in a charging pole according to claim 1
characterised in that
the power generated by the second generator is used to operate an HMI unit, a controller and/or a communication unit,
wherein the HMI unit, the controller and/or the communication unit are arranged in the charging pole.

12. The process for generating and delivering charging current for an electric vehicle in a charging pole according to claim 1,
characterised in that
the electricity generated by the second generator is used for charging an electric vehicle.

13. A charging pole suitable and intended for charging electric vehicles, comprising
a first energy conversion unit
a first generator connected to the energy conversion unit
characterised in that
a second generator is connected to the energy conversion unit.

14. The charging pole suitable and intended for charging electric vehicles, according to claim 13
characterised in that
the first generator and the second generator are connected to the energy conversion unit via separate linking elements.

15. The charging pole suitable and intended for charging electric vehicles according to claim 13
characterised in that
the first generator is connected to the charging cable terminal via a power line suitable and intended to conduct the generated current.

16. The charging pole suitable and intended for charging electric vehicles according to claim 15
characterised in that
the first generator is connected to one or more charging cable terminals exclusively via one or more power lines suitable and intended to conduct the generated current.

17. The charging pole suitable and intended for charging electric vehicles according to claim 15
characterised in that
a first rectifier is connected between the first generator and the charging cable connection.

18. The charging pole suitable and intended for charging electric vehicles according to claim 13
characterised in that
the second generator is connected to a battery via a power line suitable and intended to conduct the generated current.

19. The charging pole suitable and intended for charging electric vehicles according to claim 18
characterised in that
a second rectifier is connected between the second generator and the battery.

20. The charging pole suitable for charging electric vehicles and intended therefor, according to claim 13
characterised in that
the battery is connected to the energy conversion unit via a power line, the power line being intended and suitable for supplying electrical energy to the energy conversion unit.

21. The charging pole suitable for charging electric vehicles and intended therefor, according to claim 13
characterised in that
the second generator is connected to an HMI unit, a communication unit and/or a controller via a power line suitable and intended to conduct the generated current.

22. The charging pole suitable for charging electric vehicles and intended therefor, according to claim 13
characterised in that
the battery is connected to the first rectifier via an inverter and a power line.

23. The charging pole suitable for charging electric vehicles and intended therefor, according to claim 13
characterised in that
the battery is connected to the charging cable connection via a DC converter and a power line.

24. The charging pole suitable for charging electric vehicles and intended therefor, according to claim 13
characterised in that
the first generator is intended and suitable for generating current with a voltage greater than 100V.

25. The charging pole suitable for charging electric vehicles and intended therefor, according to claim 13
characterised in that
the second generator is intended and suitable for generating current with a voltage lower than 250V, e.g. 220V domestic current.
